(19) United States
(12) Patent Application Publication
(10) Pub. No.: US 2008/0010237 A1
(43) Pub. Date: Jan. 10, 2008

(54) System and Method for Managing Multi-Dimensional Data

(75) Inventors: Arumugam V. SUDHAKAR, Haryana (IN); Nalin Negi, Haryana (IN); Charu Mital, Uttar Pradesh (IN); Sanjay Khanna, New Delhi (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/428,973

(22) Filed: Jul. 6, 2006

(51) Int. Cl. G06F 17/30

(52) U.S. Cl. 707/2

(57) ABSTRACT

The present invention provides a system, method and computer program product for managing multi-dimensional data. The management of the multi-dimensional data includes generating policy-compliant journal and accounting entries by processing the data segments of the multi-dimensional data. One or more data segments in the multi-dimensional data are assigned one or more keywords by a user. The keywords are combined with arithmetic operators to generate rules, based on predefined compliance policies. The rules are operated to generate one or more data outputs. These data outputs are posted as journal and accounting entries to a ledger.

### BACKGROUND OF THE INVENTION

1. Field of the Invention

The present invention generally relates to the field of data analysis, and more particularly to processing data in a multi-dimensional data.

2. Background Art

There are various accounting systems that provide various journal and accounting entries. These accounting systems have to ensure that the journal and accounting entries comply with statutory Generally Accepted Accounting Principles (GAAP) provisions and other internal policies of the firm. The generation of these journal and accounting entries requires processing of multi-dimensional data, which may be in the form of a large number of interlinked tables. Typical examples of multi-dimensional data include a ledger or a daybook (such as a General Ledger system, Extended Spread Sheet database (Essbase), or multiple Microsoft Excel files), which contain records of all the accounts used by a firm.

In the existing solutions, the journal and accounting entries have been generated by using spread sheet applications, such as, for example, Microsoft Excel (MS Excel®) based spread sheet templates. The data to be processed is extracted from the multi-dimensional data and arranged in the form of MS Excel® sheets. These MS Excel® sheets are inter-linked through formulas and references. The journal and accounting entries need to be generated within a span of three to four days, generally at month end by executing the formulas in the MS Excel® sheets.

However, there are a number of problems associated with existing solutions. The volume of journal and accounting entries is large, and since the existing system requires manual processing, the workload at month-end increases. The linking of a large number of MS Excel® sheets through references and formulas increases the complexity of processing. The existing system does not provide user-level security to the historical data in the multiple MS Excel® sheets. As a result, compliance with the GAAP provisions and internal policies becomes difficult. Further, policies with which the various entries need to comply may change with time. The change in policies requires that the formulas and references of the MS Excel® sheets are updated. This is a cumbersome process due to the complexity of the existing system.

Given the foregoing, what is needed is a system, method and computer program product for the management of multi-dimensional data generating policy-compliant journal and accounting entries, which reduces the amount of manual labor involved.

### BRIEF SUMMARY OF THE INVENTION

The present invention meets the above-identified needs by providing a system, method and computer program product for managing multi-dimensional data.

The present invention provides a system, method and computer program product for managing multi-dimensional data. The management of the multi-dimensional data includes generating policy-compliant journal and accounting entries by processing the data segments of the multi-dimensional data. One or more data segments in the multi-dimensional data are assigned one or more keywords by a user. The keywords are combined with arithmetic operators to generate rules, based on predefined compliance policies. The rules are operated to generate one or more data outputs. These data outputs are posted as journal and accounting entries to a ledger.

Further features and advantages of the present invention as well as the structure and operation of various embodiments of the present invention are described in detail below with reference to the accompanying drawings.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary system in which an embodiment of the present invention is implemented.

FIG. 2 is a flowchart illustrating a process for managing multi-dimensional data according to one embodiment of the present invention.

FIG. 3 is an exemplary window or screen shot generated by the graphical user interface of the present invention.

FIG. 4 is another exemplary window or screen shot generated by the graphical user interface of the present invention.

FIG. 5 is yet another exemplary window or screen shot generated by the graphical user interface of the present invention.

FIG. 6 is yet another exemplary window or screen shot generated by the graphical user interface of the present invention.

FIG. 7 is a block diagram of an exemplary computer system useful for implementing the present invention.

### DETAILED DESCRIPTION OF THE INVENTION

### I. Introduction

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

### II. Overview

The present invention is directed to a system, method and computer program product for managing multi-dimensional data. This multi-dimensional data needs to be processed to generate various journal and accounting entries. The journal and accounting entries need to comply with the statutory Generally Accepted Accounting Principles (GAAP) provisions and other internal policies of a firm. The system described herein provides a user-friendly, efficient and controlled tool to automatically generate such entries. Such entries are automatically posted to the ledger.

The present invention is now described in more detail herein in terms of the above exemplary system. This is for convenience only and is not intended to limit the application of the present invention. In fact, after reading the following description, it will be apparent to one skilled in the relevant art(s) how to implement the following invention in alternative embodiments e.g., a manufacturing environment, for generating Management Information Systems (MIS) reports, etc.

The terms “user,” “authorized user”, “first authorized user”, “second authorized user” and/or the plural form of these terms are used interchangeably throughout herein to refer to those persons or entities capable of accessing, using, being affected by and/or benefiting from the tool that the present invention provides for managing multi-dimensional data.

### III. System

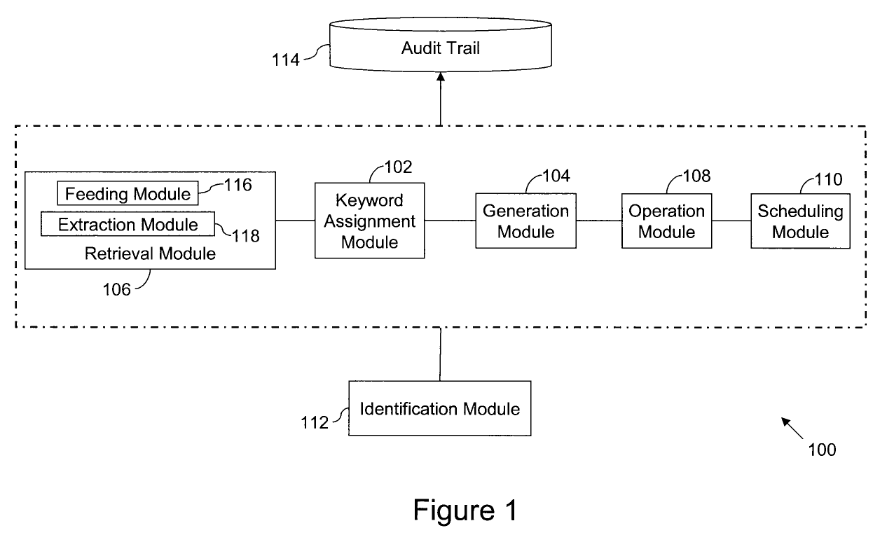

FIG. 1 is a system diagram of an exemplary system 100 for managing multi-dimensional data, in which an embodiment of the present invention is implemented.

System 100 may be used to manage multi-dimensional data, which may include, for example, a ledger or a daybook of a firm. A ledger is a record in which the commercial accounts of a firm are maintained. The management of such multi-dimensional data (ledger or a daybook) may include, for example, authenticating users to access the multi-dimensional data, identifying rights and permissions of the users, and generating journal and accounting entries by processing the multi-dimensional data. The journal and accounting entries may be required, for example, to establish compliance with one or more regulatory standards, such as GAAP provisions and other internal policies of the firm. The policy-compliant journal and accounting entries are automatically generated and posted to the ledger.

System 100 includes a keyword assignment module 102, a generation module 104, a retrieval module 106, an operation module 108, a scheduling module 110, an identification module 112 and an audit trail 114. Keyword assignment module 102 enables one or more first authorized users to assign one or more keywords to one or more data segments of the multi-dimensional data. The multi-dimensional data may be, for example, a ledger or a daybook of a firm which may be in the form of databases such as General Ledger system, Extended Spread Sheet database (Essbase), or in the form of multiple Microsoft Excel® files. Each data segment may be a ledger entry, which is in the form of a numerical figure. The first authorized users may assign any alpha-numeric keyword to the data segments, for example, ‘credit_{—}05’, ‘card fee_{—}06’, or, ‘ABC’. However, a user may also assign a logical keyword (for example, ‘credit_{—}05’) to relate to the data segment (credit of the year 2005). The keywords assigned by the first authorized users are stored in a database of system 100.

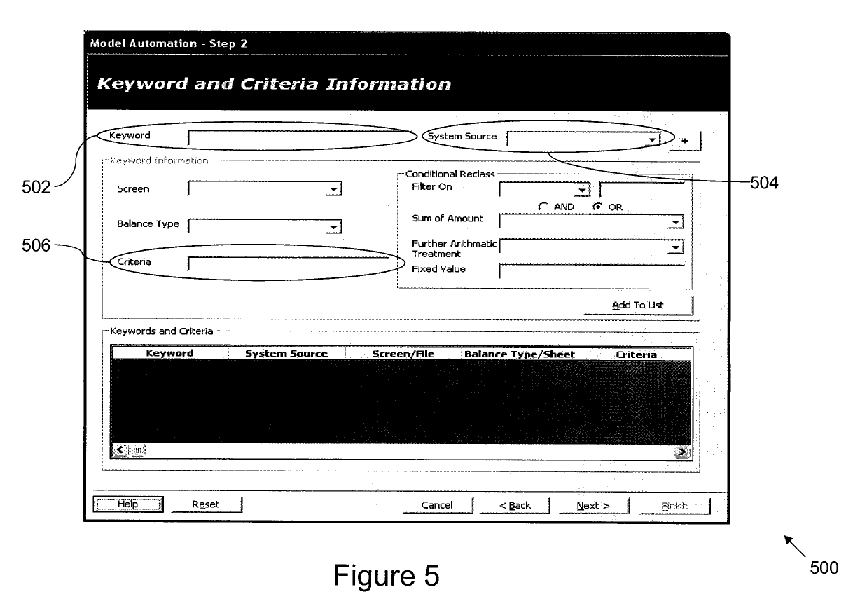

Generation module 104 generates one or more rules by combining at least one of the one or more keywords with one or more operators. The rules are mathematical equations formed by combining various keywords with one or more arithmetic, logical or aggregate operators. The rules are a representation of the operations to be performed on the data segments of the multi-dimensional data. These rules are generated based on predefined policies. The predefined policies may include, for example, regulatory standards such as GAAP, or internal policies of a firm such as its best practices. The generated rules are stored in the database of system 100. A set of one or more rules is called a business model. For example, a user may generate a business model for deferring an annual credit card fee in compliance with GAAP policies. In such a case, generation module 104 enables the user to create a rule to divide the annual card fee by twelve, which is the total number of months in a year. This rule generated is stored as a business model in the database of system 100. A detailed description of the functionalities of generation module 104 is provided with reference to FIG. 5.

Retrieval module 106 retrieves the one or more data segments from the multi-dimensional data. The retrieved data segments may be in the form of numerical figures. Retrieval module 106 includes a feeding module 116 and an extraction module 118. Feeding module 116 enables one or more second authorized users to feed the data segments into the database of system 100. Feeding the data segments may include, for example, manually feeding the numerical figures into the database of system 100, or copying the numerical figures from the Microsoft Excel files to the database of system 100, and the like.

Extraction module 118 extracts the data segments to be retrieved from the multi-dimensional data. The extraction is performed based on one or more parameters provided by a user. The parameter provided may be, for example, a path of the Microsoft Excel files, a General Ledger system account number, and the like.

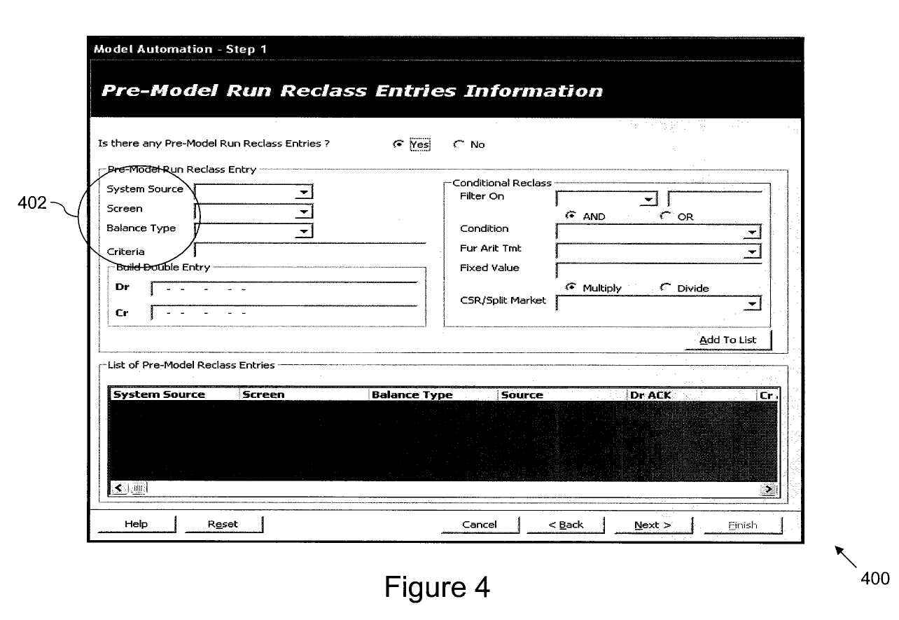

A more detailed description of the functionalities of retrieval module 106 is provided in conjunction with FIG. 4.

Operation module 108 operates one or more rules to generate one or more data outputs. Operation module 108 executes the mathematical equations represented by rules on the data segments of the multi-dimensional data. The execution of the rules results in data outputs. The data outputs may include, for example, journal and accounting entries. The journal and accounting entries generated are in compliance with the predefined policies, since the rules are generated in accordance with the predefined policies. The journal and accounting entries are automatically posted to the ledger.

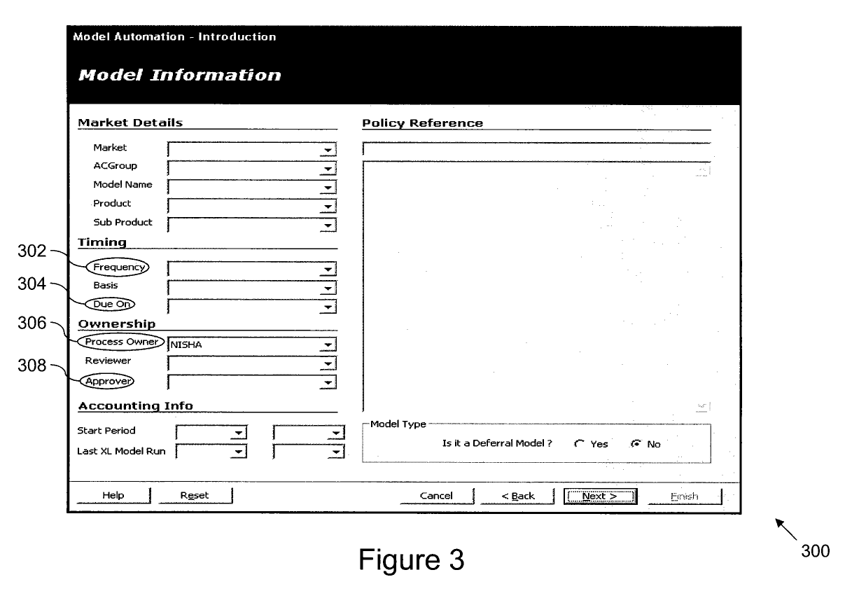

Scheduling module 110 schedules the operation of one or more rules and hence automates the operation of the rules at a predefined time, which may be specified by a user. Scheduling module 110 schedules the operation of a business model (a set of rules) at a predefined time specified by a user. For example, a user may specify that a particular rule is to be put into operation at the end of each month. Accordingly, the rule is operated at the end of each month. A more detailed description of the functionalities of scheduling module 110 is provided in conjunction with FIG. 3.

Identification module 112 identifies rights of one or more users based on the authentication of the one or more users. A user may access system 100 by providing his/her login credentials. The user is authenticated by comparing the login credentials of the user with the login details in the database of system 100. Based on the authentication, identification module 112 identifies the rights and the allowed access level for the user. The user may be authenticated as a first authorized user or a second authorized user. The first authorized user may be same as the second authorized user. A user may be authenticated to access the multi-dimensional data. For example, a user may be authenticated to access the data stored in a General Ledger system.

Audit trail 114 is a record of one or more activities performed on the multi-dimensional data. The activities performed on the multi-dimensional data may include, for example, assigning keywords, generating rules, operating the rules, accessing system 100, approving the generated rules, and the like. Each activity performed on the multi-dimensional data is recorded in audit trail 114 along with the time and the details of the user who has performed the activity.

System 100 may further include an approval module (not shown in FIG. 1) to approve the rules generated by generation module 104. The approval module may seek the approval of one or more users. Approving the rules generated by generation module 104 may include, for example, reviewing the rules for checking compliance with the predefined policies. Operation module 108 operates the rules only after they are approved by the approving module. A business model (a set of rules) is generated and submitted for the approval of one or more users, who may approve it. Thereafter, the business model is executed as per the scheduling.

System 100 may further include an updating module (not shown in FIG. 1). The business models may be categorized as standard and non-standard business models. The standard business models may be further classified into various sub-categories. For example, sub-category M1 may refer to all standard business models relating to deferral of credit card fee, sub-category M2 may refer to all standard business models relating to deferral of commission cost and so on. A user may make changes to a standard business model. In various embodiments of the present invention, the user may be authenticated by identification module 112 for making the changes to a standard business model. The updating module replicates these changes to all the standard business models in the sub-category of that standard business model. For example, a user may change the deferral time from 12 months to six months in a standard model in sub-category M1 based on the change in predefined policies. Accordingly, the updating module updates the deferral time to six months in all the standard business models in sub-category M1.

System 100 may further include a trend analysis module (not shown in FIG. 1), which generates one or more reports based on the data outputs of the business models. The reports may include, for example, trend data reports, graphs, and statistical charts. The trend analysis module identifies unusual trends in the data outputs of the business models.

### IV. Process

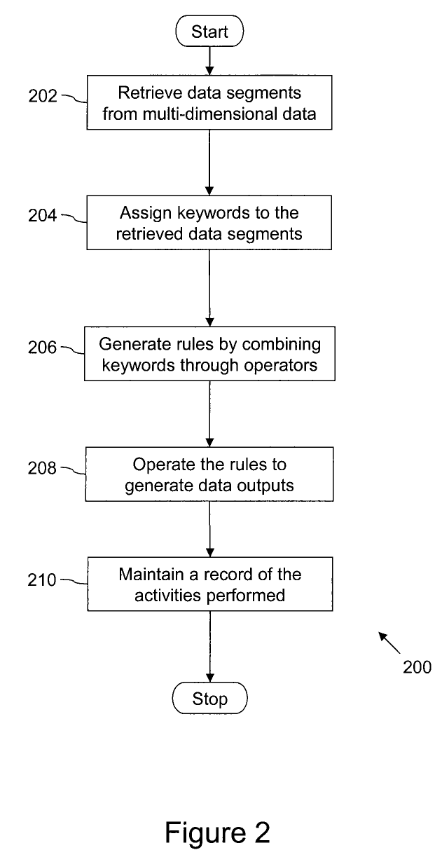

FIG. 2 shows a flowchart illustrating a process 200 for managing multi-dimensional data. Process 200 begins at step 202, where one or more data segments are retrieved from the multi-dimensional data. The multi-dimensional data may be a ledger or a daybook, which may be maintained in the form of databases such as General Ledger system, Extended Spread Sheet database (Essbase), or in the form of multiple Microsoft Excel files. The retrieved data segments may be, for example, a ledger entry in the form of numerical figures.

Step 202 may also include a step of feeding the data segments manually. The data segments are fed manually by one or more second authorized users. The step of feeding the data segments manually may include, for example, manually feeding the numerical figures into a database, or copying the numerical figures from multiple Microsoft Excel files or a General Ledger system screen to the database.

The step 202 may also include a step of automatically extracting data segments from the multi-dimensional data. For extraction of the data segments, a parameter is provided by a user to identify the data segments in the multi-dimensional data. The retrieval of the data segments is performed by using a retrieval module such as retrieval module 106.

At step 204, one or more keywords are assigned by one or more first authorized users to the retrieved data segments. The first authorized users may assign any alpha-numeric keyword to the data segments, for example, ‘credit_{—}05’, ‘card fee_{—}06’, or ‘ABC’. The keywords assigned by the first authorized users are stored in the database.

At step 206, one or more rules are generated by combining at least one of the one or more keywords with one or more operators. Each of the rules is a mathematical equation formed by combining the keywords with one or more arithmetic, logical or aggregate operators. The rules are generated based on predefined policies. These predefined policies may include, for example, regulatory standards such as GAAP or internal policies of the firm such as its best practices. The rules are stored in the database. A set of one or more rules is called a business model. For example, a user may generate a business model for deferring the annual card fee in compliance with GAAP policies. In such a case, generation module 104 enables the user to create a rule to divide the annual card fee by twelve, which is the total number of months in a year. This rule generated is stored as a business model in the database.

At step 208, the rules are operated to generate one or more data outputs. The operation includes the execution of the mathematical equations represented by the rules. The operation of the rules results in data outputs. These data outputs may include, for example, journal and accounting entries. The journal and accounting entries generated herein are in compliance with the predefined policies.

At step 210, a record of the activities performed on the multi-dimensional data by the users is maintained. The activities performed on the multi-dimensional data may include, for example, assigning keywords, generating rules, operating the rules, accessing system 100, approving the generated rules, and the like. Each activity performed on the multi-dimensional data is recorded in the database along with the time and the details of the user who has performed the activity.

Process 200 may also include a step of scheduling the operation of one or more rules. The rules are scheduled to be automatically operated at a predefined time. The predefined time may be specified by a user. Process 200 may also include a step for posting the policy-compliant journal and accounting entries automatically to a ledger at a predefined time.

Process 200 may also include a step of identifying rights for one or more users based on the authentication. The login credentials provided by a user are compared with the login details listed in the database. If the login credentials of the user match the login details in the database, the user is authenticated to be an authorized user. The allowed access-level and user rights of the authorized user are identified as listed in the database. Based on the allowed access-level, the user is allowed to perform one or more steps of process 200. The user may be authenticated as a first authorized user or a second authorized user. The first authorized user may be same as the second authorized user. A user may be authenticated to access the multi-dimensional data. For example, a user may be authenticated to access a General Ledger system.

Process 200 may also include a step of approving the rules generated at step 206. This step seeks the approval of one or more users. For example, the users may review the rules to check compliance with the predefined policies. Step 208 is performed only after the rules are approved by the users. The business models are submitted for approval of the users. The users approve the business models, which are run as per the schedule.

Process 200 may further include a step for updating the business models. The business models may be categorized as standard business models and non-standard business models. The standard business models may be further classified into various sub-categories. A user may make changes to a standard business model of a sub-category. These changes are updated to all the standard business models in that sub-category.

Process 200 may further include a step for performing trend analysis of the data outputs of the business models. One or more reports are generated, based on the data outputs of the business models. The reports may include, for example, trend data reports, graphs, and statistics. Unusual trends in the data outputs of the business models are also identified.

### V. Example Implementations

The working of various modules of system 100 has been explained herein by means of FIGS. 3, 4, 5 and 6, each of which is an exemplary window or screen shot of the Graphical User Interface (GUI) of system 100.

FIG. 3 shows an exemplary window or screen shot 300 generated by the graphical user interface of system 100. Screen shot 300 is a graphical user interface, which enables a user to input information related to a business model. The information may include, for example, details of the owner of the business model, the approver of the business model; details of the scheduling of the business model, and the like. The user may be, for example, a process owner, a reviewer, or an approver.

Screen shot 300 includes a set of drop down menus such as a Frequency menu 302, a Due On menu 304, a Process Owner menu 306, and an Approver menu 308 enabling users to input information related to business models. Frequency menu 302 enables a user to input the frequency with which a business model is to be operated or run, which may be, for example, weekly, monthly, quarterly, and the like. Due on menu 304 enables a user to input the due date on which the business model is due to be run. The information input by the user is stored in the database. The information related to a business model is used by a scheduling module such as scheduling module 110 to schedule the running of the business model.

Process Owner menu 306 enables the user to input the details related to the owner of a business model. In various embodiments of the present invention, the owner is a user who has created the business model. The owner of the business model may be the user who is currently logged in. In that case, the process owner menu is automatically populated. A business model may be submitted for approval by authorized users. Approver menu 308 enables the user to input details related to the approver of a business model. The approver is a user who reviews the business model, and checks the business model for compliance with predefined policies using an approval module such as the approval module (not shown in FIG. 1) of system 100. The information input by the user is stored in the database of system 100.

FIG. 4 shows another exemplary window or screen shot 400 generated by the graphical user interface of system 100. Screen shot 400 is a graphical user interface, which enables a user to input information related to the retrieval of the data segments from the multi-dimensional data. Screen shot 400 includes a set of drop down menus 402. Each of drop down menus 402 enables a user to input information related to the retrieval of data segments required by a business model. The information input by the user may include one or more parameters used by extraction module 118 to identify the data segments to be retrieved. The parameters may be, for example, a path of the Microsoft Excel files, a General Ledger system account number, and the like. The information related to the retrieval of data segments input by the user is stored in the database of system 100. This information may be used by a retrieval module such as retrieval module 106 to retrieve data segments from the multi-dimensional data.

FIG. 5 shows another exemplary window or screen shot 500 generated by the graphical user interface of system 100. Screen shot 500 is a graphical user interface that enables one or more first authorized users to input information related to the assignment of one or more keywords to one or more data segments of the multi-dimensional data. Screen shot 500 includes a keyword section 502, a system source drop down menu 504 and a criteria section 506. Keyword section 502 enables the first authorized users to input a user-defined name for a keyword. System source drop down menu 504 enables the first authorized users to specify the system source. For example, a user may provide the keyword ‘A’ in keyword section 502 and the system source as ‘General Ledger system Full ACK’ in system source drop down menu 504. Accordingly, keyword ‘A’ represents the full account of the General Ledger system for the model.

Criteria section 506 enables a user to specify one or more parameters (criteria). Extraction module 118 uses the parameters provided by the user to identify the data segments to be retrieved from the multi-dimensional data. For example, if a user specifies system source as ‘General Ledger system Full ACK’ in system source dropdown menu 504, then the criteria specified in criteria section 506 may be the account number (ACK). Similarly, if a user specifies system as ‘Other Excel Files’ in system source dropdown menu 504, then the criteria specified in criteria section 506 may be the file path and the sheet name. The criteria and the associated keyword are stored in the database of system 100.

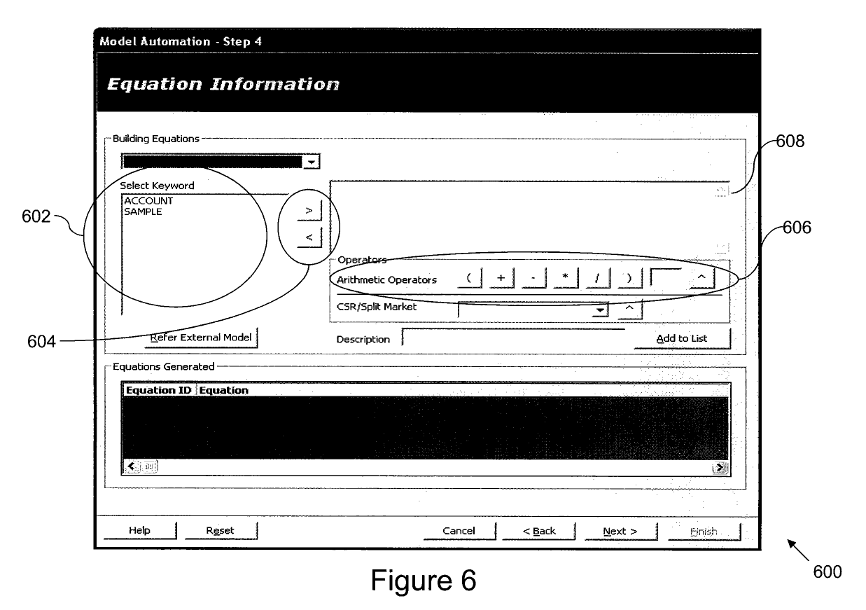

FIG. 6 shows another exemplary window or screen shot 600 generated by the graphical user interface of system 100. Screen shot 600 is a graphical user interface that enables a user to input information related to the generation of rules. Screen shot 600 includes a keyword list 602, a set of add/remove buttons 604, a list of operators 606, and an operations entry section 608. Keyword list 602 is a list of keywords assigned by one or more first authorized users by using a keyword assignment module such as keyword assignment module 102. Section 608 is the area of screen shot 600 where the mathematical equation representing the rule is formed. Add/remove buttons 604 allow the users to add or remove one or more keywords from keyword list 602 to section 608. The list of operators 606 is a set of logical, arithmetic or mathematical operators that are combined with the keywords to form mathematical equations. The mathematical equation representing a rule is stored in the database of system 100.

The present invention (i.e., system 100, process 200 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

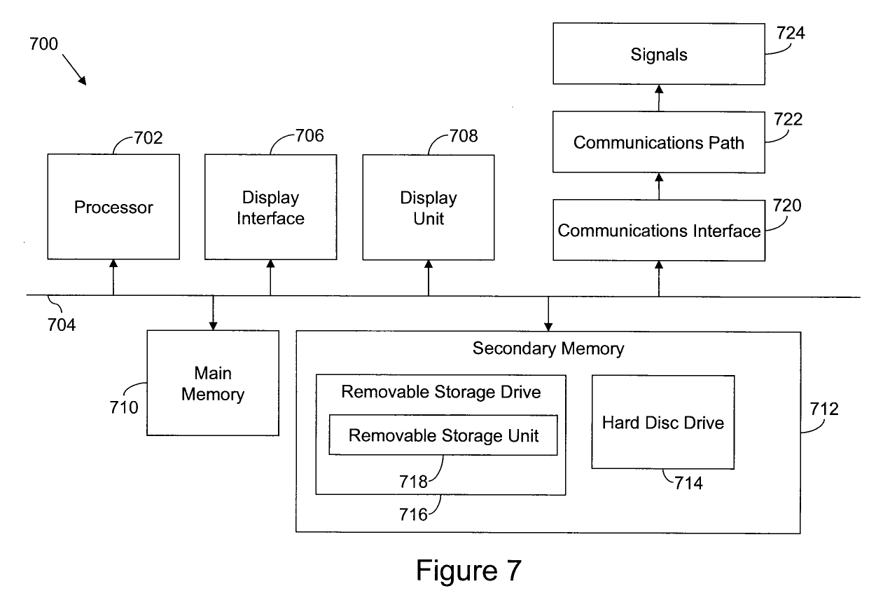

An example of a computer system 700 is shown in FIG. 7. Computer system 700 includes one or more processors, such as processor 702. Processor 702 is connected to a communication infrastructure 704 (e.g., a communication bus, cross-over bar, or network). Various software embodiments are described in terms of this exemplary computer system. After reading this description, it will become apparent to a person skilled in the relevant art(s) how to implement the invention using other computer systems and/or architectures.

Computer system 700 can include a display interface 706 that forwards graphics, text, and other data from communication infrastructure 704 (or from a frame buffer not shown) for display on a display unit 708.

Computer system 700 also includes a main memory 710, preferably random access memory (RAM), and may also include a secondary memory 712. Secondary memory 712 may include, for example, a hard disk drive 714 and/or a removable storage drive 716, representing a floppy disk drive, a magnetic tape drive, an optical disk drive, etc. Removable storage drive 716 reads from and/or writes to a removable storage unit 718 in a well known manner. Removable storage unit 718 represents a floppy disk, magnetic tape, optical disk, etc., which is read by and written to by removable storage drive 716. As will be appreciated, removable storage unit 718 includes a computer usable storage medium having stored therein computer software and/or data.

In alternative embodiments, secondary memory 712 may include other similar devices for allowing computer programs or other instructions to be loaded into computer system 700. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a Personal Computer Memory Card International Association (PCMCIA) slot and card, etc. Software and data transferred via communications interface 720 are in the form of signals 724 which may be electronic, electromagnetic, optical or other signals capable of being received by communications interface 720. These signals 724 are provided to communications interface 720 via a communications path (e.g., channel) 722. This communications path 722 carries signals 724 and may be implemented using wire or cable, fiber optics, a telephone line, a cellular link, an radio frequency (RF) link and other communications channels.

In this document, the terms ‘computer program medium’ and ‘computer usable medium’ are used to generally refer to media such as removable storage drive 716, a hard disk installed in hard disk drive 714, and signals 724. These computer program products provide software to computer system 700. The invention is directed to such computer program products.

Computer programs (also referred to as computer control logic) are stored in main memory 710 and/or secondary memory 712. Computer programs may also be received via communications interface 720. Such computer programs, when executed, enable computer system 700 to perform the features of the present invention, as discussed herein. In particular, the computer programs, when executed, enable processor 702 to perform the features of the present invention. Accordingly, such computer programs represent controllers of computer system 700.

In an embodiment where the invention is implemented using software, the software may be stored in a computer program product and loaded into computer system 700 using removable storage drive 716, hard disk drive 714 or communications interface 720. The control logic (software), when executed by processor 702, causes processor 702 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

An advantage of the present invention is that it automates the process of generating policy-compliant journal and accounting entries, thereby reducing the manual labor involved.

Another advantage of the present invention is that it enables segregation of user rights and permissions, based on the authentication and allowed access-level.

Another advantage of the present invention is that it automatically extracts the relevant data segments from the multi-dimensional data.

Another advantage of the present invention is that it maintains a database of the extracted data segments.

Another advantage of the present invention is that it maintains a complete track of the activities performed on the multi-dimensional data.

Another advantage of the present invention is that it has a structured workflow control.

Yet another advantage of the present invention is that it automatically posts the policy-compliant journal and accounting entries to the ledger.

### VI. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for managing multi-dimensional data, comprising the steps of:
(a) assigning one or more keywords to one or more data segments of the multi-dimensional data, the one or more keywords being assigned by one or more first authorized users;
(b) generating one or more rules based on one or more predefined policies, each of the one or more rules being generated by combining at least one of the one or more keywords with one or more operators; and
(c) operating the one or more rules to generate one or more data outputs.

2. The method of claim 1, further comprising the step of:
(d) retrieving the one or more data segments from the multi-dimensional data, the step of retrieving comprising at least one of the steps of:
(i) feeding the one or more data segments, the one or more data segments being fed by one or more second authorized users, and
(ii) extracting the one or more data segments based on one or more parameters.

3. The method of claim 1, further comprising the step of:
(d) scheduling the operation of the one or more rules.

4. The method of claim 1, further comprising the step of:
(d) identifying rights for one or more users, the rights being identified based on authentication of the one or more users.

5. The method of claim 4, wherein the one or more users comprise at least one of the one or more first authorized users and the one or more second authorized users.

6. The method of claim 1, further comprising the step of:
(d) maintaining a record of one or more activities performed on the multi-dimensional data.

7. A system for managing multi-dimensional data, the system comprising:
a keyword assignment module which enables one or more first authorized users to assign one or more keywords to one or more data segments of the multi-dimensional data;
a generation module which generates one or more rules based on one or more predefined policies, each of the one or more rules being generated by combining at least one of the one or more keywords with one or more operators; and
an operation module which operates the one or more rules to generate one or more data outputs.

8. The system of claim 7, further comprising:
a retrieval module which retrieves the one or more data segments from the multi-dimensional data, the retrieval module comprising:
a feeding module which enables the one or more second authorized users to feed the one or more data segments; and
an extraction module which extracts the one or more data segments based on one or more parameters.

9. The system of claim 7, further comprising:
a scheduling module which schedules the operation of the one or more rules.

10. The system of claim 7, further comprising:
an identification module which identifies rights for one or more users, the rights being identified based on authentication of the one or more users.

11. The system of claim 7, further comprising:
an audit trail, the audit trail being a record of one or more activities performed on the multi-dimensional data.

12. A computer program product comprising a computer usable medium having control logic stored therein for causing a computer to manage multi-dimensional data, said control logic comprising:
first computer readable program code means for causing the computer to assign one or more keywords to one or more data segments of the multi-dimensional data, the one or more keywords being assigned by one or more first authorized users;
second computer readable program code means for causing the computer to generate one or more rules based on one or more predefined policies, each of the one or more rules being generated by combining at least one of the one or more keywords with one or more operators; and
third computer readable program code means for causing the computer to operate the one or more rules to generate one or more data outputs.

13. The computer program product of claim 12, further comprising:
a fourth computer readable program code means for causing the computer to retrieve the one or more data segments from the multi-dimensional data, the fourth computer readable program code means comprising:
a fifth computer readable program code means for causing the computer to enable the one or more second authorized users to feed the one or more data segments; and
a sixth computer readable program code means for causing the computer to extract the one or more data segments based on one or more parameters.

14. The computer program product of claim 12, further comprising:
a seventh computer readable program code means for causing the computer to schedule the operation of the one or more rules.

15. The computer program product of claim 12, further comprising:
an eighth computer readable program code means for causing the computer to identify rights for one or more users, the rights being identified based on authentication of the one or more users.

16. The computer program product of claim 12, further comprising:
a ninth computer readable program code means for causing the computer to maintain a record of one or more activities performed on the multi-dimensional data.
